(19) United States
(12) Patent Application Publication
(10) Pub. No.: US 2011/0263267 A1
(43) Pub. Date: Oct. 27, 2011

(54) METHOD FOR TERMINAL-BASED RECOGNITION OF HOME BASE STATIONS IN A CELLULAR TELEPHONE SYSTEM BY MEANS OF SUPPORT BY THE CELLULAR NETWORK

(76) Inventors: Axel Klatt, Koln (DE); Harald Schmitt, Bendorf (DE)

(21) Appl. No.: 12/678,370

(22) PCT Filed: Jun. 26, 2008
(86) PCT No.: PCT/EP08/05226

§ 371 Date: Mar. 16, 2010

(30) Foreign Application Priority Data
Sep. 21, 2007 (DE) 10 2007 045 408.4

(51) Int. Cl. H04W 4/00

(52) U.S. Cl. 455/456.1

(57) ABSTRACT

A method for the geographical location of a mobile radio terminal within a cellular mobile radio network, in which each cell in the mobile radio network can be identified using an identifier containing a cell identification and an area identification and wherein an identifier is emitted and wherein the mobile radio terminal is suitable for receiving and processing such identifiers and for storing one or more identifiers, wherein geographical location of the mobile radio terminal within the cellular mobile radio network is effected by comparing the currently received identifier with one or more stored identifiers, with modification of the cell identification and/or of the area identification in the identifier of a cell involving transmission of a supplementary information item to the mobile radio terminal and the new identifier being stored instead of the old identifier.

The invention relates to a method for geographic location-finding of a cellular terminal device within a cellular telephone network, in which each cell of the cellular network can be identified using an identifier containing a cell identification and an area identification and whereby an identifier is emitted and whereby the cellular terminal device is suited for receiving and processing these identifiers and storing one or more identifiers, geographic location-finding of the cellular terminal device within the cellular network taking place by comparison of the currently received identifier to one or more stored identifiers.

This invention relates especially to a method or an arrangement for implementation of an optimized, terminal-based search function of a cellular terminal device in a cellular telephone system, for example according to the GERAN, UTRAN, E-UTRAN, cdma2000, UMB, WiMAX, etc., standard, for finding a usable home base station while avoiding a continuous or periodic search by making available additional information about the change of the configuration of the cellular network by the cellular network itself.

The installation of so-called “home base stations” (also called home BTS, Home BS, HBS, Home-eNB, CSG cells, etc.) in a cellular telephone system is known. They are used in one of the typical main applications as an expansion of a public cellular telephone system in uncovered or poorly covered inside areas (or residences, houses, offices), but can also be used for other reasons even with adequate coverage by the cellular network. Linking of these home BS to the cellular telephone system of the operator (PLMN) is conventionally done over xDSL or Ethernet, etc. Another typical feature of this type of home BS is the fact that only a limited number of registered users are allowed access to this home BS. One typical application is the use of the home BS in one's own home, residence, or in a vacation home to which only a limited number of registered cellular customers of the cellular network (PLMNs) have access. This could also be a 4-member family.

With respect to controlling access to home BS, the following options are known:

Different Network Identifiers (PLMN IDs) within the Cellular System

The home BS uses a network identifier (PLMN ID) that is different from the public cellular network. Only the registered users may use the home BS. For public users, the use of the network identifier and thus of the home BS is prohibited.

The disadvantages of this option are that the number of PLMN IDs is greatly limited and thus differentiation of several home BS requires additional solutions. Furthermore, the power consumption of the terminal devices that the registered users use is accordingly increased since the periodic network search is set to a short interval. This is necessary to minimize the time interval from reaching the location of the home BS to the actual use of the home BS. Other disadvantages of this option lie in the increased administration cost that the network operator must bear to accept the additional PLMN ID.

Normal Cell Change without own Cellular Network Identifier

Another option for controlling access of a home BS is to use the normal mobility procedures within a network identifier. For this purpose, the home BS must be integrated into the public cellular network and the corresponding adjacency relations, such as between all other cells of the cellular network, to the public cellular network must be set up. Control for changing between the public cellular network and the home BS takes place by suitable parameterization of the cell reselection process. Furthermore, public users on the home BS can be refused.

A major disadvantage of this option is that the battery life of the cellular terminal devices of the public users is adversely affected since they must often measure cells of the home base stations that are not to be used. Furthermore, the cost for integration of many home BS into a public cellular network is relatively high. This cost additionally increases in excess proportion when mobility of the actual home BS per se is allowed; for example, the owner of the home BS generally changes it between his vacation residence and his own home. The method of using the normal cell-changing procedures is used in, for example, UMA (“Unlicensed Mobile Access”) or “Generic Access”.

### Storage of Cell Data of the Macronetwork to Avoid Searching for Home BS

Another possibility is to store a “cell fingerprint” in the cellular terminal device. A cellular terminal device stores cell information of several transmitting stations of the public cellular network in the geographic location of the individual home BS. The cellular terminal device periodically compares the current network configuration of the public cellular network to the stored “cell fingerprint”. As soon as the cellular terminal device ascertains agreement, the cellular terminal device is in the geographic vicinity or possibly even in range of the home BS and the terminal device starts the search of the home BS.

This method that is used according to the prior art is based on a statistical probability that within a cellular telephone system (PLMN), such a cell constellation is unique (or there is at least a very low probability of again finding exactly the same constellation at another geographic position within the cellular network). In the “cell fingerprint” method, the major disadvantage is that renewing the “cell fingerprint,” necessary due to changes of the cell configuration by the network operator, currently can only take place manually by the user of a cellular terminal device, the user in the normal case, however, not being notified by way of network reconfigurations of the cellular operator; typically, the user only notices this change when his cellular terminal device does not automatically find his own home BS again.

The decisive disadvantage of the prior art is that a change of the configuration of the macrocell network in the vicinity of the location of the home BS will not trigger the search for the home BS because the “cell fingerprint” used for the search is not found.

The object of the invention is to make available a method that, even when the identifier of a cell changes or when the identifier of an area changes in a cellular network, reliably allows geographic location-finding of the cellular terminal device within the cellular network, which can be used, for example, to find the individual home BS again by the cellular terminal device.

This object is achieved according to the invention by a method according to claim 1.

It is especially advantageous here that in a method for geographic location-finding of a cellular terminal device within a cellular network - in which each cell of the cellular network can be identified using an identifier containing a cell identification and an area identification and whereby an identifier is emitted and whereby the cellular terminal device is suited for receiving and processing these identifiers and storing one or more identifiers, whereby a geographic location-finding of the cellular terminal device within the cellular network takes place by comparison of the currently received identifier to one or more stored identifiers, in a modification of the cell identification and/or the area identification of the identifier of the cell additional information being transmitted to the cellular terminal device and the search for the home BS being triggered in spite of changing the macrocells of the cellular network and after the sought home BS is found again—the new cell identification or area identification is stored instead of the old cell identification or area identification. They are then used instead of the old identifiers for searching for the home BS.

Other advantageous embodiments of the invention are given in the dependent claims.

It is advantageous if a search of the cellular terminal device for a base station is triggered upon identification of a geographic position stored in the cellular terminal device. In this way at periodic intervals, location-finding can take place, the search for a home base station only being triggered when a stored position has been identified in the geographic vicinity or range of the home base station.

It is furthermore advantageous if the identifiers transmitted from the cellular network to the cellular terminal device have additional geographic information.

Preferably, when additional information that indicates modification of an identification is received, a search of the cellular terminal device for a base station is initiated.

It is advantageous if the additional information indicates a modification of the cell identification of a macrocell in the cellular telephone network.

It is advantageous if the additional information indicates a modification of the area identification of a macrocell in the cellular network, especially modification of the tracking area identity (TAI) or the location area identity (LAI) or the routing area identity (RAI) of a macrocell in the cellular telephone network.

Preferably, the additional information is transmitted each time after modification of a cell identification and/or an area identification on a broadcast channel BCH of the cellular telephone network.

Preferably, the additional information is not transmitted in binary form, but in increment form, comprising at least two values.

Preferably, at least one identifier of a certain cell is stored in the cellular terminal device for identification of a geographic position in the range of a certain base station.

In one preferred embodiment, the cellular terminal device is a base station that has a computer network-based link to the cellular network, the base station being deactivated in the detection of a change of location of the base station.

Furthermore, the invention relates to a computer program product comprising a computer program that can run on a computing unit, which executes the method according to the invention according to one of claims 1 to 10, when it is done on a computing unit.

The network-side support of the search function of a cellular terminal device that enables the cellular terminal device, in spite of a change of the configuration of the macrocell network, to implement an intelligent search function and still to ensure reliable finding of the individual home BS again when the macrocell network changes in the geographic vicinity of the home BS location is especially advantageous.

It is especially advantageous if a stored “cell fingerprint” in a cellular network is automatically renewed for the case in which the cell information is changed by a network operator.

The prerequisite for use of the proposed method according to the invention is the use of cell information or area information of the cellular telephone system (macrocells) for intelligent support of the search function of the cellular terminal device.

The invention is explained below based on figures. Here:

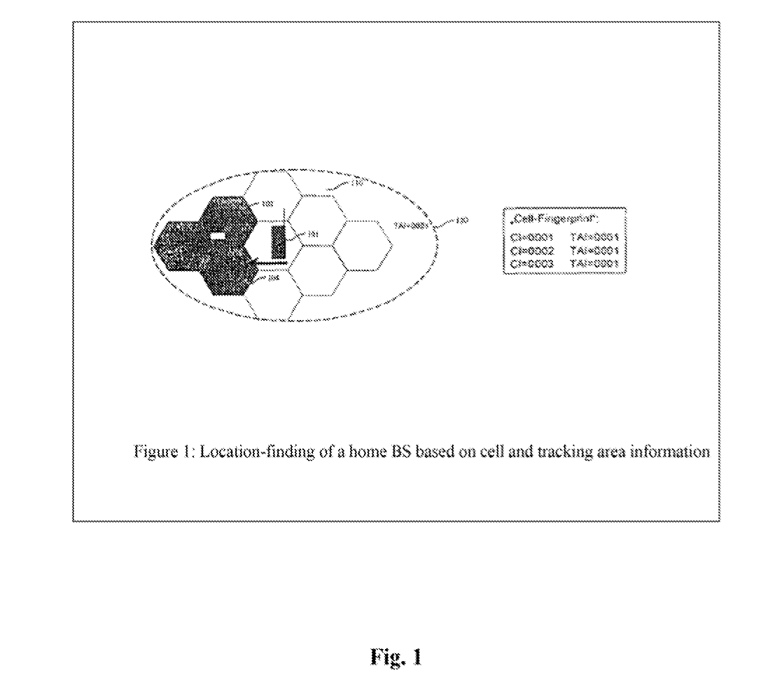

FIG. 1: shows a diagrammatic visualization of finding the location of a cellular terminal device in a cellular telephone network;

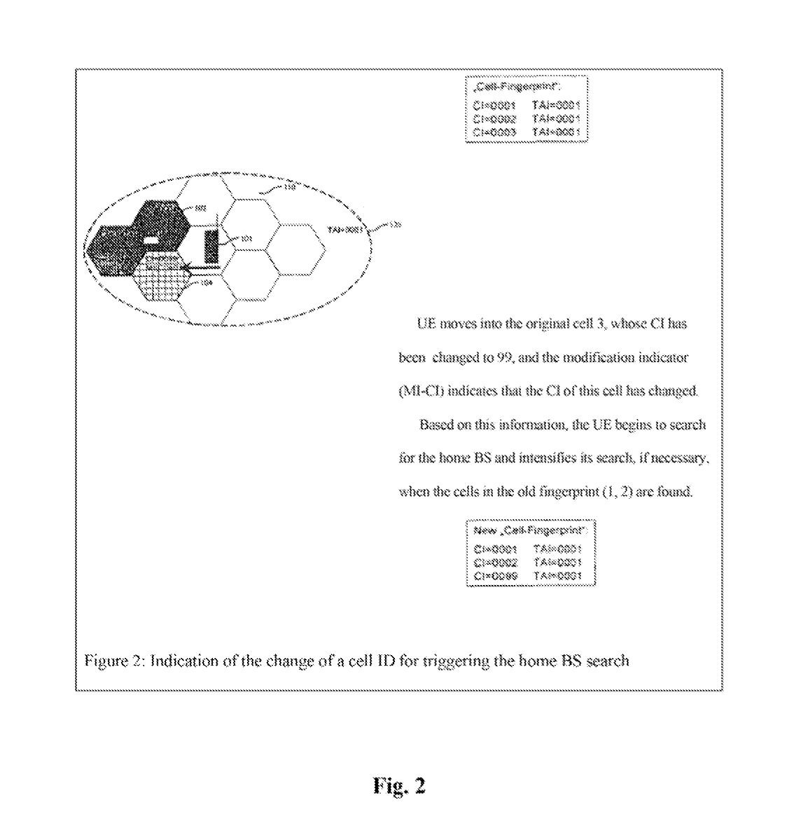

FIG. 2: shows a diagrammatic visualization of the indication of a change of a cell identification CI;

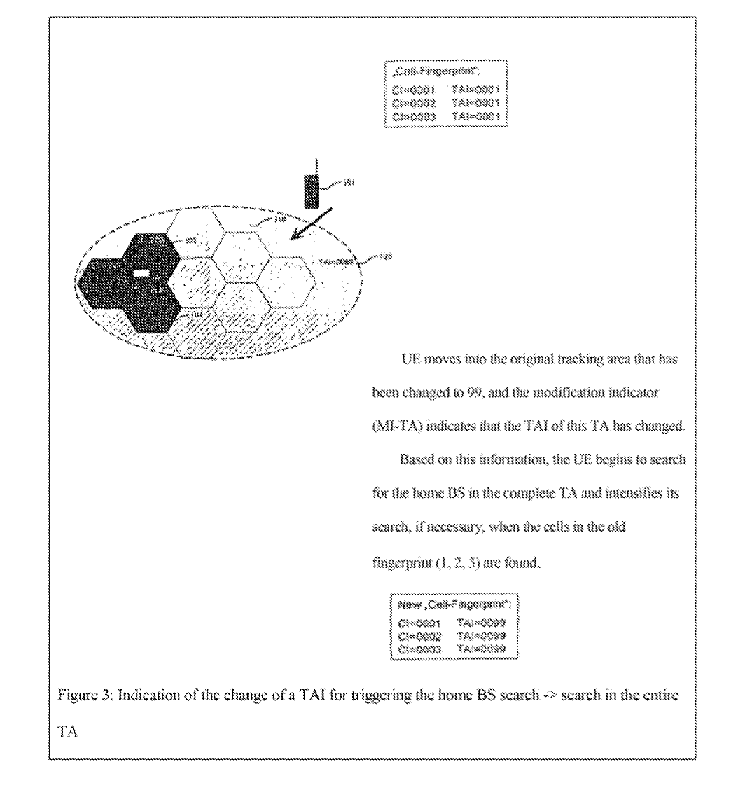

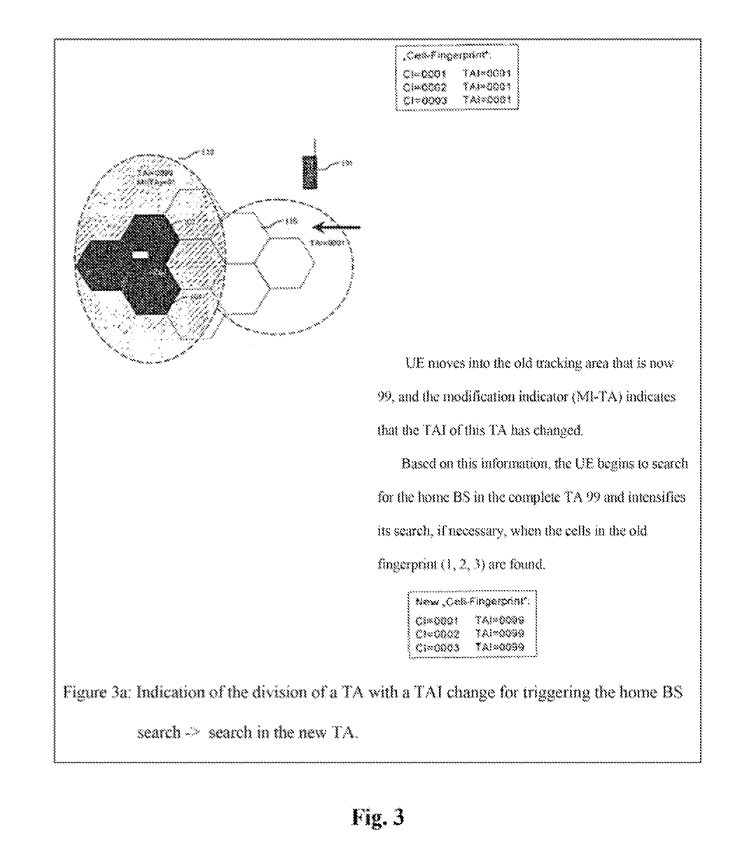

FIG. 3: shows a diagrammatic visualization of the indication of the change of an area identification TAI;

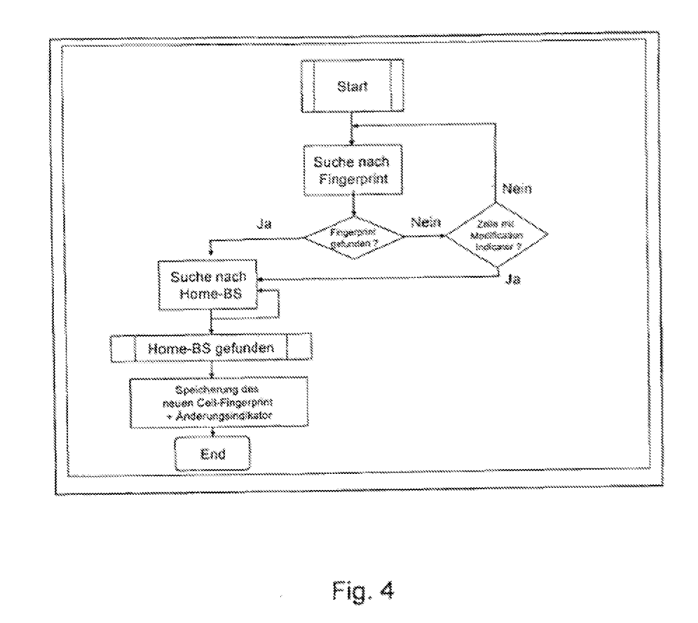

FIG. 4: shows the diagrammatic progression of the method according to the invention.

When a cellular terminal device 101, for example in the geographic vicinity of its own home BS 100, has stored information from six cells of the macrocell network 110 as a “cell fingerprint” with cell identity (CI) and tracking area identity (TAI) (in the case of E-UTRAN, otherwise a corresponding area information such as the location area (LA) for UMTS or GSM), a cell constellation would be, as illustrated below, the initiator for the cellular terminal device to search for its own home BS 100:

Typical “cell fingerprint” in the vicinity of the individual home BS:

| | |
|---|---|
| CI - 00001 | TAI - 00001 |
| CI = 00002 | TAI = 00001 |
| CI = 00003 | TAI = 00001 |
| CI = 00004 | TAI = 00001 |
| CI = 00005 | TAI = 00002 |
| CI = 00006 | TAI = 00002 |

This method that is used according to the prior art is based on the statistical probability that within a cellular telephone system (PLMN), such a cell constellation is unique (or there is at least a very low probability of again finding exactly the same constellation again at another geographic position within the cellular network). The major disadvantage of this method is the fact that a change of the macrocell constellation (for example, changing a single cell ID that has been used for the cell fingerprint) is sufficient, that the cellular terminal device never again finds the cell constellation used for the search, and thus also does not trigger a search for the home BS.

To avoid this disadvantage, it is proposed according to the invention that the macrocell network 110 makes support available to the cellular terminal device 101 for the case in which parameters such as cell ID and/or TAI of the macrocell 102, 103, 104 have changed in order to trigger a search for the home BS 100 by the cellular terminal device 101 in spite of this change.

FIG. 4 shows the diagrammatic progression of the method according to the invention. The flow chart according to FIG. 4 is explained below by way of example.

If, for example, the cell ID 104 of cell 00004 is changed to 00010, a cellular terminal device 101 that uses the original cell fingerprint (see above) would not trigger the search for the home BS 100.

Change of a cell (cell ID) of the original “cell fingerprint”:

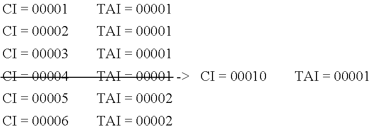

According to the method of the invention, since the cell ID of a cell has been changed from 00004 to 00010, an additional modification indicator (value tag) is transmitted with the information that (recently) the individual cell ID of the macrocell has been changed. In this way, an additional help position is delivered to the cellular terminal device, in spite of failure to find the actual original cell fingerprint, to still trigger a search for its own home BS.

If, accordingly, several cell IDs have been changed, each of the cells 102, 103, 104 would emit this additional indicator and the cellular terminal device 101 would have to search for its own home BS 100 in a correspondingly larger geographic area.

Accordingly, another separate indicator is proposed according to the invention for the case in which the tracking area identity (TAI) 120 of one of the macrocells 102, 103, 104 has been changed (for example by division of a larger TA into several smaller ones). The change index in a TA 120 leads to a search of the cellular terminal device 101 within the entire TA 120 until its own home BS 100 has been successfully found again (see flow chart in FIG. 4). Then, the cellular terminal device 101 will internally store the new cell fingerprint together with the change identifier for further location-finding of its own home BS-100 and use it for further searching for its own home BS.

The use of more than one stored “cell fingerprint” is not ruled out. The implementation option allows more than one “cell fingerprint” per home BS 100, as well as the storage of several “cell fingerprints” for different home BS 100.

As an alternative version, the proposed method also enables implementation in the home BS (for example, implemented by an installed receiver for measuring the macrocells) per se, in order, for example, when the macrocell constellation changes to allow indications regarding the change of placement of the home BS. For this purpose, the home BS also stores a corresponding “cell fingerprint” of the surrounding cellular network (optionally expanded with additional parameters, such as, for example, the PLMN ID) and uses this information to be automatically deactivated when the “cell fingerprint” has changed, without the modification indicator also having been changed. In particular when using the PLMN ID of the macrocell network, this is a reliable indicator that the home BS has been operating in a different country. A change of the “cell fingerprint” for the same PLMN ID indicates a change of the location within the same country. Deactivation of the home BS when the location changes can thus take place automatically.

1. A method for geographic location-finding of a cellular terminal device (101) within a cellular telephone network (110), in which each cell (102, 103, 104) of the cellular network (110) can be identified using an identifier containing a cell identification and an area identification, and whereby an identifier is emitted and whereby the cellular terminal device (101) is suited for receiving and processing these identifiers and storing one or more identifiers, a geographic location-finding of the cellular terminal device (101) within the cellular network (110) taking place by comparison of the currently received identifier to one or more stored identifiers, characterized in that when a cell identification and/or area identification of the identifier of a cell (102, 103, 104) is modified, additional information is transmitted to the cellular terminal device (101), and the new identifier is stored instead of the old identifier.

2. The method according to claim 1, wherein a search of the cellular terminal device (101) for a base station (100) is triggered upon identification of a geographic position stored in the cellular terminal device (101).

3. The method according to claim 1, wherein the identifiers transmitted from the cellular telephone network (110) to the cellular terminal device (101) have additional geographic information.

4. The method according to claim 1, wherein when additional information that indicates modification of an identification is received, a search of the cellular terminal device (101) for a base station (100) is initiated.

5. The method according to claim lone of the preceding claim 1, wherein the additional information indicates a modification of the cell identification of a macrocell (102, 103, 104) in the cellular telephone network.

6. The method according to claim 1, wherein the additional information indicates a modification of the area identification (120) of a macrocell (102, 103, 104) in the cellular telephone network (110), especially a modification of the tracking area identity (TAI) or the location area identity (LAI) or the routing area identity (RAI) of a macrocell (102, 103, 104) in the cellular telephone network (110).

7. The method according to claim lone of the preceding claim 1, wherein the additional information is transmitted each time after a modification of a cell identification and/or an area identification on a broadcast channel BCH of the cellular telephone network (110).

8. The method according to claim lone of the preceding claims, wherein the additional information is not transmitted in binary form, but rather in increment form comprising at least two values.

9. The method according to claim lone of the preceding claim 1, wherein at least one identifier of a certain cell (102, 103, 104) is stored in the cellular terminal device (101) for identification of a geographic position in the geographic vicinity or in the range of a certain base station (100).

10. The method according to claim 1, wherein the cellular terminal device (101) is a base station (100) that has a computer network-based link to the cellular network (110) and that is deactivated for the detection of a change of location of the base station (100).

11. A computer program product comprising a computer program that can run on a computing unit and that executes the method according to one of the preceding claims when it is done on a computing unit.
